(19) United States
(12) Patent Application Publication
(10) Pub. No.: US 2015/0327351 A1
(43) Pub. Date: Nov. 12, 2015

(54) Clothes Dryer Static Charge Dissipating Device, System Therewith And Method Of Reducing Static Charge Buildup In Clothes In Clothes Dryers

(71) Applicant: Federal-Mogul Powertrain, Inc., Southfield, MI (US)

(72) Inventors: Annette Marchione, Tabernacle, NJ (US); Jaime Marrero, Chalfont, PA (US); Brian Lieb, Phoenixville, PA (US); Danielle Fong, San Francisco, CA (US); Jessica Fegeley, Bergenfield, NJ (US); Melissa Shaine, Marlton, NJ (US); Erika Saienni, Newark, DE (US)

(73) Assignee: Federal-Mogul Powertrain, Inc., Southfield, MI (US)

(21) Appl. No.: 14/274,483

(22) Filed: May 9, 2014

(51) Int. Cl. H05F 3/02; D06F 58/04

(52) U.S. Cl. CPC H05F 3/02; D06F 58/04

(57) ABSTRACT

A clothes dryer static charge dissipating device, system therewith, and method of reducing static charge build-up in clothes tumbling in a dryer drum are provided. The clothes dryer static charge dissipating device includes a flexible conductive member extending between a first end and a second end. The first end is configured for attachment to a surface of a dryer drum for conjoint rotation therewith and the second end is free to extend radially inwardly from the surface of the dryer drum during rotational movement of the dryer drum. A conductive ground member is in operable electrical communication with the flexible conductive member and is configured for operable attachment to an electrical ground of the dryer drum.

### BACKGROUND OF THE INVENTION

1. Technical Field

This invention relates generally to static charge reducing devices, and more particularly to clothes dryer static charge reducing devices.

2. Related Art

Clothes dried in a tumbling dryer typically generate static electricity. The static charge generally causes the clothes to cling together and to one another, often referred to as “static cling.” Static cling can be extremely frustrating to the person separating and folding the clothes, as well as to the person wearing the clothes, as not only does it cause the clothing to appear unsightly, but it also acts as a source of attraction for hair, dust and the like, further causing the clothing to appear unsightly.

Efforts have been made to reduce static build-up within clothes tumbling in rotary clothes dryers, largely including disposable anti-static fabric sheets, however, these products are only suitable for single use, which means they must be regularly replenished with new, unused sheets. In addition to having to repeatedly purchase new sheets, anti-static sheets do not conduct and dissipate static charge; rather, they deposit a wax residue on clothes to prevent static from being generated. As a result, over time the deposited wax can reduce the luster of the clothes, and further, can cause allergic reactions. Accordingly, use of anti-static sheets results in waste, expense, diminishes the original luster of the clothes, and potentially causes allergic reactions.

### SUMMARY OF THE INVENTION

In accordance with one aspect of the invention, a clothes dryer static dissipating device is provided. The device includes a flexible conductive member extending between a first end and a second end. The first end is configured for attachment to a surface of a dryer drum for conjoint rotation therewith and the second end is free to extend radially inwardly from the surface of the dryer drum during rotational movement of the dryer drum. Further, a conductive ground member is in operable electrical communication with the flexible conductive member and is configured for operable attachment to an electrical ground of the dryer drum.

In accordance with a further aspect of the invention, the second end can be weighted to facilitate biasing the second end radially inwardly from the surface of the dryer drum.

In accordance with a further aspect of the invention, the conductive ground member can extend outwardly from the first end for operable attachment to the electrical ground.

In accordance with a further aspect of the invention, the flexible conductive member can be constructed from interlaced yarn, with at least some of the interlaced yarn being electrically conductive.

In accordance with a further aspect of the invention, a receptacle can be provided adjacent the second end of the flexible conductive member and a weight member can be disposed in the receptacle to bias the second end radially inwardly during rotation of the dryer drum.

In accordance with a further aspect of the invention, the flexible conductive member can be one of a woven, knit or braided member.

In accordance with a further aspect of the invention, the first end can be provided having a magnetic member to facilitate attachment of the first end to the surface of the dryer drum.

In accordance with a further aspect of the invention, the first end can be configured for attachment to a tumbler fin of the dryer drum.

In accordance with a further aspect of the invention, a clothes dryer static charge dissipating system is provided. The system includes a dryer drum having an inner surface including a plurality of radially inwardly extending tumbler fins to facilitate tumbling clothes within the dryer drum and an electrical ground. The system further includes a flexible conductive member extending between a first end and a second end. The first end is operably attached to the inner surface of the dryer drum for conjoint rotation therewith and the second end is configured to extend radially inwardly from the inner surface of the dryer drum during rotation of the dryer drum. Further yet, the system includes a conductive ground member in operable electrical communication with the flexible conductive member and the electrical ground. As such, static charge generated within the tumbling clothes is conducted through the flexible conductive member and through the conductive ground member to the electrical ground, such that the static charge is dissipated from the clothes to the electrical ground.

In accordance with a further aspect of the system, the first end can be configured for attachment to one of the plurality of tumbler fins.

In accordance with a further aspect of the invention, a method of reducing static build-up in clothes tumbling in a dryer drum is provided. The method includes attaching a first end of a flexible conductive member to an inner surface of the dryer drum for conjoint rotation with the dryer drum and allowing a second end of the flexible conductive member to extend radially inwardly from and hang freely from the inner surface of the dryer drum during rotation of the dryer drum. The method further includes coupling one end of a conductive ground member in operable electrical communication with the flexible conductive member and coupling an opposite end of the conductive ground member to an electrical ground of the dryer drum.

In accordance with a further aspect of the invention, the method can further include weighting the second end to facilitate biasing the second end radially inwardly from the inner surface of the dryer drum while the dryer drum is rotating.

In accordance with a further aspect of the invention, the method can further include fabricating the flexible conductive member at least in part from electrically conductive yarn.

In accordance with a further aspect of the invention, the method can further include fabricating the flexible conductive member by one of weaving, knitting or braiding.

In accordance with a further aspect of the invention, the method can further include attaching the first end of the conductive flexible member to the inner surface of the dryer drum with a magnetic member.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1A is a side view of a clothes dryer including a clothes dryer static charge dissipating system in accordance with one embodiment of the invention;

FIG. 1B is a front view of the clothes dryer static charge dissipating system of FIG. 1; and

FIG. 2 is a perspective view of a clothes dryer static dissipating device, constructed in accordance with one embodiment of the invention, of the clothes dryer static charge dissipating system of FIGS. 1A and 1B.

### DETAILED DESCRIPTION OF PREFERRED EMBODIMENTS

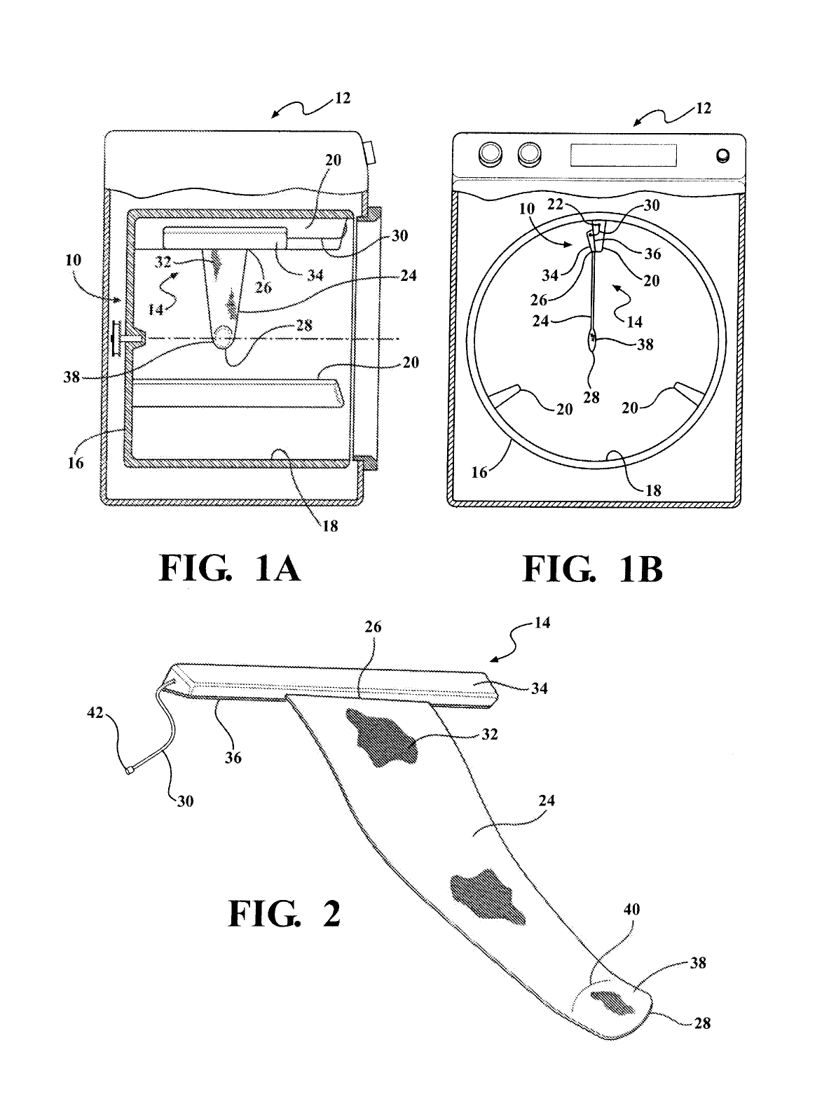

Referring in more detail to the drawings, FIGS. 1A and 1B illustrate a clothes dryer static charge dissipating system, referred to hereafter as system 10, of a clothes dryer 12, wherein the system 10 includes a clothes dryer static reducing, elimination or dissipating device, referred to hereafter as device 14, wherein the system 10 and device 14 are each constructed in accordance with one embodiment of the invention. The system 10 includes a dryer drum 16 having an inner surface 18 including a plurality of radially inwardly extending tumbler fins 20 to facilitate tumbling clothes within the dryer drum 16 and an electrical ground 22 (FIG. 1B). The device 14 of the system 10 further includes a flexible conductive member 24 extending between a first end 26 and a second end 28. The first end 26 is operably attached to the inner surface 18 of the dryer drum 16 for conjoint rotation therewith and the second end 28 extends radially inwardly from the inner surface 18 of the dryer drum 16. Further yet, the system 10, and device 14, include a conductive ground member 30 configured in operable electrical communication with the flexible conductive member 24 and the electrical ground 22. As such, static charge generated within clothes tumbling in the dryer drum 16 is dissipated and conducted through the flexible conductive member 24 and through the conductive ground member 30 to the electrical ground 22, such that the static charge is dissipated from the clothes to the electrical ground 22.

The flexible conductive member 24 can be fabricated as one of a woven, knit or braided member with yarn 32, wherein at least some or all of the yarn 32 is provided as electrically conductive yarn configured in electrical communication with the conductive ground member 30. Preferably, the electrically conductive yarn 32 extends in both a weft and warp direction to provide an interlaced network or lattice of electrically conductive material to maximize the ability of the flexible conductive member 24 to conduct static electricity from the tumbling clothing. The yarn 32 used to fabricate the flexible conductive member 24 is generally soft and nonabrasive to avoid diminishing the luster of the clothing, and can be provided as a monofilament and/or multifilament yarn. The electrically conductive yarn can be provided as a fine continuous strand of wire; as a hybrid yarn of a continuous strand of wire served or twisted with a nonconductive monofilament and/or multifilament yarn; or as a metal coated (metallized) monofilament and/or multifilament yarn, as desired.

The first end 26 of the flexible conductive member 24 is configured for operable attachment to the inner surface 18, such as to one of the tumbler fins 20, by way of example and without limitation. The device 14 is shown as having an elongate end member 34 facilitating attachment of the device 14 to the inner surface 18. The end member 34 can be formed as a flexible, semi-rigid, or rigid member, such as from a polymeric material, by way of example and without limitation. Otherwise, it should be recognized that the first end 26 could be attached directly to the inner surface 18, if desired. The end member 34 can be configured for attachment to one of the tumbler fins 20, wherein the end member 34 is shown as extending along a substantial portion of the length of the tumbler fin 20, and could be provided to extend along the full length of the tumbler fin 20. The end member 34 can be configured for attachment to the inner surface 18 via any suitable fastener or combination of fasteners, including mechanical fasteners, adhesives or otherwise, and a magnetic member 36, such as a magnet strip extending along a side surface of the end member 34 for magnetic attachment to a side surface of one of the tumbler fins.

The second end 28 extends radially inwardly toward the center of the dryer drum 16 so that the flexible conductive member 24 is more readily brought into contact with clothing as the clothing is being tumbled, thereby assuring the member 24 has ample opportunity to conduct static electricity from the clothing, and further, to facilitate tumbling of the clothing in addition to the tumbler fins 20. To facilitate biasing the second end 28 radially inwardly during use of the dryer 12, a weight member 38 can be disposed adjacent the second end 28. The weight, estimated to be about that of a hand cloth, is sufficient to bias the second end radially inwardly, however, does not create unwanted noise, such as often occurs with shoes or the like. To facilitate attachment of the weight member 38 adjacent the second end 28, the flexible conductive member 24 can be provided with a pocket or receptacle 40 sized for receipt to the weight member 38. If the flexible conductive member 24 is formed having a generally flat, single layer wall, the receptacle 40 could be formed as a pocket on an outer surface of the flexible conductive member 24. However, if the flexible conductive member 24 is formed having a generally tubular wall, similar to a sock, the weight member 38 could be disposed in a cavity thereof and fixed adjacent the second end 28, such as via a stitched seam, adhesive or otherwise.

The conductive ground member 30, such as a wire or cable, extends from the first end 26 of the flexible conductive member 24 to the electrical ground 22, and is shown here, by way of example and without limitation, as extending from the first end 26 through the end member 34 to a free end 42 configured for attachment to the electrical ground 22. The free end 42 can be fastened to the electrical ground 22 via any suitable fastening mechanism, such as a threaded fastener or snap, for example.

Obviously, many modifications and variations of the present invention are possible in light of the above teachings. It is, therefore, to be understood that within the scope of the appended claims, the invention may be practiced otherwise than as specifically described.

What is claimed is:

1. A clothes dryer static charge dissipating device, comprising:
a flexible conductive member extending between a first end and a second end, said first end being configured for attachment to a surface of a dryer drum for conjoint rotation therewith and said second end being free to extend radially inwardly from the surface of the dryer drum during rotational movement of the dryer drum; and
a conductive ground member in operable electrical communication with said flexible conductive member, said conductive ground member being configured for operable attachment to a ground member of the dryer drum.

2. The clothes dryer static charge dissipating device of claim 1 wherein said second end is weighted to facilitate biasing said second end radially inwardly from the surface of the dryer drum.

3. The clothes dryer static charge dissipating device of claim 1 wherein said conductive ground member extends outwardly from said first end.

4. The clothes dryer static charge dissipating device of claim 1 wherein said flexible conductive member is constructed from interlaced yarn, at least some of said interlaced yarn being electrically conductive.

5. The clothes dryer static charge dissipating device of claim 4 further including a receptacle adjacent said second end of said flexible conductive member and a weight member disposed in said receptacle.

6. The clothes dryer static charge dissipating device of claim 4 wherein said flexible conductive member is one of a woven, knit or braided member.

7. The clothes dryer static charge dissipating device of claim 1 wherein said first end has a magnetic member to facilitate attachment of said first end to the surface of the dryer drum.

8. The clothes dryer static charge dissipating device of claim 1 wherein said first end is configured for attachment to a tumbler fin of the dryer drum.

9. A clothes dryer static charge dissipating system, comprising:
a dryer drum having an inner surface including a plurality of radially inwardly extending tumbler fins to facilitate tumbling clothes within said dryer drum;
a ground member;
a flexible conductive member extending between a first end and a second end, said first end being operably attached to said inner surface of said drum for conjoint rotation therewith and said second end extending radially inwardly from said inner surface of said dryer drum; and
a conductive ground member in operable electrical communication with said flexible conductive member and said ground member.

10. The clothes dryer static charge dissipating system of claim 9 wherein said second end is weighted to facilitate biasing said second end radially inwardly from said inner surface of said dryer drum.

11. The clothes dryer static charge dissipating system of claim 9 wherein said conductive ground member extends from said first end to said inner surface of said dryer drum.

12. The clothes dryer static charge dissipating system of claim 9 wherein said flexible conductive member is constructed from interlaced yarn, at least some of said interlaced yarn being electrically conductive.

13. The clothes dryer static charge dissipating system of claim 12 further including a receptacle adjacent said second end of said flexible conductive member and a weight member disposed in said receptacle.

14. The clothes dryer static charge dissipating system of claim 12 wherein said flexible conductive member is one of a woven, knit or braided member.

15. The clothes dryer static charge dissipating system of claim 9 wherein said first end has a magnetic member to facilitate attaching said first end to said inner surface of said dryer drum.

16. The clothes dryer static charge dissipating system of claim 9 wherein said first end is configured for attachment to one of said plurality of tumbler fins.

17. A method of reducing static charge build-up in clothes tumbling in a dryer drum, comprising:
attaching a first end of a flexible conductive member to an inner surface of the dryer drum for conjoint rotation with the dryer drum and allowing a second end of the flexible conductive member to extend radially inwardly from and hang freely from the inner surface of the dryer drum; and
coupling one end of a conductive ground member in operable electrical communication with the flexible conductive member and coupling an opposite end of the conductive ground member to a ground member of the dryer drum.

18. The method of claim 17 further including weighting the second end to facilitate biasing the second end radially inwardly from the inner surface of the dryer drum while the dryer drum is rotating.

19. The method of claim 18 further including disposing a weight member in a receptacle of the flexible conductive member adjacent the second end of the flexible conductive member.

20. The method of claim 17 further including fabricating the flexible conductive at least in part from electrically conductive yarn.

21. The method of claim 20 further including performing the fabricating by one of weaving, knitting or braiding.

22. The method of claim 17 further including attaching the first end to the inner surface with a magnetic member.

23. The method of claim 17 further including attaching the first end to a tumbler fin of the dryer drum.
